(19) United States
(12) Patent Application Publication
(10) Pub. No.: US 2012/0062823 A1
(43) Pub. Date: Mar. 15, 2012

(54) LIQUID CRYSTAL DISPLAY DEVICE

(75) Inventors: Tomoo Takatani, Osaka (JP); Hiroshi Fukushima, Osaka (JP)

(73) Assignee: SHARP KABUSHIKI KAISHA, Osaka-shi (JP)

(21) Appl. No.: 13/321,141

(22) PCT Filed: Feb. 4, 2010
(86) PCT No.: PCT/JP2010/051632

§ 371 Date: Nov. 17, 2011

(51) Int. Cl. G02F 1/1335

(52) U.S. Cl. 349/96

(57) ABSTRACT

Provided is a liquid crystal display device having a liquid crystal layer of which the thickness does not easily change even in the case that the liquid crystal display device has an air-gapless structure. The liquid crystal display device includes, in this order toward a display surface: a first substrate; a liquid crystal layer; and a second substrate. The second substrate contains, in this order toward the display surface, a polarizer, an interlayer including an adhesive layer, and a protective plate. The polarizer and the protective plate are in close contact with each other via the interlayer. The adhesive layer contains a material that has an elastic modulus of not higher than 1.0×10⁵ Pa.

### REFERENCE TO RELATED APPLICATIONS

This application is a national stage application under 35 USC 371 of International Application No. PCT/JP2010/051632, filed Feb. 4, 2010, which claims the priority of Japanese Application No. JP2009-132476, filed Jun. 1, 2009, the contents of which prior applications are incorporated herein by reference.

### TECHNICAL FIELD

The present invention relates to a liquid crystal display device. More specifically, the present invention relates to a liquid crystal display device suitably used for thin mobile terminals such as cell phones, personal digital assistants (PDAs), and smartphones.

### BACKGROUND ART

Today, flat panel displays (FPDs) of which the thickness can be reduced have been popular as display devices such as displays for TVs, PCs, and mobile terminals. Examples of the FPDs having been put into practical use today include liquid crystal displays (LCDs), plasma display panels (PDPs), and organic electroluminescence (EL) displays.

Among these FPDs, liquid crystal display devices particularly can be easily thinned, consume less power, and are applicable to a wide range of display sizes from small sizes to large sizes. Liquid crystal display devices are therefore used for various applications such as displays for TVs, PCs, and mobile terminals. Usually, display on liquid crystal display devices is performed by electrically controlling the alignment directions of liquid crystals between a pair of substrates to adjust the amount of light supplied from the backlight.

These mobile terminals such as cell phones, PDAs, and smartphones in some cases have a protective plate on the outermost surface of the liquid crystal display panel so that the display surface of the liquid crystal display panel is protected and the design of the terminal is improved. Also, an air-gapless technology has been developed in which the surface of the polarizer of the liquid crystal display panel and the surface of the front plate such as a protective plate or a touch panel are bonded closely to each other.

For example, Patent Document 1 discloses a liquid crystal display device that has a protective plate attached to the polarizer which is attached to the display surface of the liquid crystal cell. This polarizer consists only of a polarizing film, and the polarizing film is directly bonded to the display surface of the liquid crystal cell and the protective plate by an ultraviolet-curable adhesive.

Meanwhile, liquid crystal display devices usually have a polarizer attached to the display surface thereof, and this structure leads to emission of linearly polarized light from the display surface of the liquid crystal display device. Hence, for example, the display surface, when viewed through polarized sunglasses, sometimes appears in deep black, providing no images.

Patent Documents 2 and 3, for example, teach ways to solve this problem, based on the uniaxiality of polarized sunglasses; that is, the documents respectively teach arrangement of a biaxially oriented film on the polarizer and arrangement of a half-wave plate, which rotates the polarization direction of the light emitted from the transmission axis of the polarizer by a certain angle, on the polarizer.
Patent Document 1: JP 2-27121 U
Patent Document 2: JP 59-189325 A
Patent Document 3: JP 2008-83115 A

### SUMMARY OF THE INVENTION

### Problems to be Solved by the Invention

In the case of producing a liquid crystal display device having an air-gapless structure formed by bonding the surface of the polarizer and the surface of the front plate such as a protective plate or a touch panel closely to each other by an adhesive layer, however, application of a certain amount or more of heat to the liquid crystal display device tends to vary the thickness of the liquid crystal layer, easily leading to a problem in the optical design of the light passing through the liquid crystal layer.

The present invention has been made in view of the above state of the art, and aims to provide a liquid crystal display device having a liquid crystal layer of which the thickness does not easily change even in the case that the liquid crystal display device has an air-gapless structure.

### Means for Solving the Problems

The present inventors have made various studies on the cause of easy change in the thickness of the liquid crystal layer in the case of forming an air-gapless structure. As a result, the present inventors have found that the respective components constituting the air-gapless structure, upon receiving a certain amount of heat, suffer from thermal expansion or thermal contraction. Since the respective components constituting the air-gapless structure are integrally formed, the thermal expansion or thermal contraction not only affects the alignment of the polarizer and the protective plate but also changes the thickness (cell gap) of the liquid crystal layer located farther from the display surface (i.e. the side opposite to the protective plate) than the polarizer. Unevenness in the thickness of the liquid crystal layer changes the optical property of the light passing through the liquid crystal layer depending on the region of the liquid crystal layer, so that appropriate display cannot be performed.

The present inventors have also found that unevenness in the thickness of the liquid crystal layer is more significant in the case that a component providing a level difference on the surface of the polarizer or the protective film, such as a flame constituting the portion surrounding the display region of the liquid crystal display device, is arranged between the polarizer and the protective plate.

Further, in the case that an adhesive layer for the air-gapless structure is directly attached to a film which is thin and stretched in a certain direction, such as a polarizer or a phase plate, application of a certain amount of heat has been found to produce a force of restoring the original form of the stretched portion against the stretched direction, and therefore the error in the design particularly because of the size change is large. Such an error may possibly cause separation within the adhesive layer or peeling of the adhesive layer from other component(s) to eventually cause decomposition (breakage) of the air-gapless structure.

The present inventors have made intensive studies to solve such a problem, and focused on the properties of the adhesive layer for bonding the respective components. As a result, the present inventors have found that controlling the elastic modulus of the material of the adhesive layer to be not higher than a specific value contributes to reduction of the effect of the change in the sizes of the respective components constituting the air-gapless structure, provided on the other structures, even in the case that a certain amount of heat is applied. Thereby the above problem has been admirably solved and the present invention has been completed.

That is, the present invention is a liquid crystal display device comprising, in this order toward a display surface: a first substrate; a liquid crystal layer; and a second substrate, the second substrate containing, in this order toward the display surface, a polarizer, an interlayer including an adhesive layer, and a protective plate, the polarizer and the protective plate being in close contact with each other via the interlayer, the adhesive layer containing a material that has an elastic modulus of not higher than 1.0×10⁵ Pa.

As above, the liquid crystal display device of the present invention includes a first substrate, a liquid crystal layer, and a second substrate arranged in this order toward the display surface. That is, the liquid crystal display device of the present invention has a structure in which a liquid crystal layer is sandwiched between a pair of substrates. Therefore, providing components such as wiring, electrodes, and semiconductor elements to the pair of substrates enables application of voltage in the liquid crystal layer to control the alignment of liquid crystal molecules.

The second substrate includes a polarizer, an interlayer including an adhesive layer, and a protective plate. That is, the second substrate has an air-gapless structure in which the polarizer and the protective plate are in close contact with each other via the interlayer. Such an air-gapless structure makes it possible to reduce the number of the interfaces between regions with different refractive indexes and reduce the reflected components, compared to structures including an air layer between the polarizer and the protective plate. Thereby, a thin liquid crystal display device desired for mobile terminals can be produced.

The elastic modulus of the material constituting the adhesive layer is not higher than 1.0×10⁵ Pa. Actually, the elastic modulus of the adhesive layer of a double-sided tape (for example, double-sided tape for air-gapless structure (trade name: 8187, product of 3M)) conventionally used for the air-gapless structure is mostly 1.0×10⁶ to 1.0×10⁷ Pa. However, in the case of further decreasing the elastic modulus to not higher than 1.0×10⁵ Pa as in the present invention, an adhesive layer can be produced which can sufficiently respond to a size change upon thermal expansion or thermal contraction. Accordingly, a change in the thickness of the liquid crystal layer can be prevented. Note that a difference in the elastic modulus, if it is a single order of magnitude, is a great difference as a physical property of the adhesive layer. The material of the adhesive layer may include a single kind or multiple kinds of materials. In the case that the interlayer includes multiple adhesive layers, one of the adhesive layers should have an elastic modulus in the above range, and preferably, all the adhesive layers have an elastic modulus in the above range. Also, there may be a case that the interlayer includes multiple adhesive layers and one of the adhesive layers has an elastic modulus in the above range. In such a case, preferably, the layer having an elastic modulus in the above range is arranged on the side closer to the polarizer in terms of reducing the change in the thickness of the liquid crystal layer owing to unevenness of the polarizer (level difference absorbing function) and reduction of the effect of thermal contraction of the polarizer (stress releasing function). More preferably, the layer is arranged on the side closer to the protective plate in terms of releasing the stress caused by the protective film produced from a harder material.

The structure of the liquid crystal display device of the present invention is not particularly limited as long as the liquid crystal display device includes the above components.

Preferable embodiments of the liquid crystal display device of the present invention will be described in detail below.

The interlayer preferably includes a double-sided tape consisting of an adhesive layer. In the present invention, the interlayer preferably includes a double-sided tape for bonding the polarizer and the protective plate in terms of forming an air-gapless structure. Alternatively, in terms of reducing the number of interfaces between regions with different refractive indexes to reduce the reflectance and forming a thin air-gapless structure, the double-sided tape preferably consists only of the adhesive layer without any other components.

The interlayer preferably includes a double-sided tape consisting of a first adhesive layer, a base material, and a second adhesive layer. The above double-sided tape preferably contains a base material as well as an adhesive layers as the bases, in terms of durability and versatility. Further, in the present invention, the interlayer preferably includes a double-sided tape for bonding the polarizer and the protective plate, in terms of forming an air-gapless structure. Such provision of a certain added value to a part (e.g. base material) of the double-sided tape makes it possible to efficiently improve the characteristics of the liquid crystal display device.

The base material preferably has different refractive indexes in respective directions within a single plane. Thus, polarization of the uniaxially polarized light emitted from the polarizer is modulated (depolarized) when the light passes through the above base material, and therefore normal display is provided at any angle even when the display surface is viewed through polarized glasses. Examples of the base material include biaxial phase plates. The base material, however, is preferably one stretched in three or more directions, not in specific two directions, in a single plane. That is, since the base material is not particularly limited as long as it can modulate the polarization of the uniaxially polarized light passing therethrough, the stretching direction does not need to be limited to only two directions and may be three or more directions to give a random axiality. Since a base material having a certain level of thickness can be further thinned in the case of being stretched in three or more directions, the thickness of the liquid crystal display device can also be further reduced.

The interlayer preferably further includes a capacitive touch panel. Arranging a capacitive touch panel between the polarizer and protective film of the second substrate of the present invention enables to produce a touch-panel liquid crystal display device. A capacitive touch panel is a touch panel that includes at least a substrate and a conductive film as the basic components, and detects a change in the capacitance between the finger and the conductive film so as to determine the position of the finger touch. In this case, the interlayer preferably has a structure in which a double-sided tape including an adhesive layer is arranged on either side of the capacitive touch panel.

The protective plate is preferably a resistive touch panel. Forming the protective plate of the second substrate in the present invention as a resistive touch panel enables to produce a touch-panel liquid crystal display device. A resistive touch panel is a touch panel that includes at least a substrate and a conductive film as the basic components, and measures the electric resistance changing according to the pressure applied by an object coming in contact with the touch panel so as to determine the position of the contact.

### Effect of the Invention

The present invention can provide a highly reliable liquid crystal display device that has a reduced reflectance and a reduced thickness owing to the air-gapless structure, and has a liquid crystal layer of which the thickness does not easily change even in the case that the liquid crystal display device receives a certain amount of heat.

### BRIEF DESCRIPTION OF DRAWINGS

FIG. 1 is a schematic cross-sectional view of a liquid crystal display device of a first embodiment.

FIG. 2 is a schematic cross-sectional view of a second substrate provided in the liquid crystal display device of the first embodiment.

FIG. 3 is a schematic plan view of the second substrate provided in the liquid crystal display device of the first embodiment.

FIG. 4 is a schematic cross-sectional view of a substrate having the same structure as the second substrate in the present invention and including a conventionally used adhesive layer, after the substrate has received a certain amount of heat.

FIG. 5 is a perspective conceptual view illustrating optical properties of respective components constituting an AGL structure of the liquid crystal display device of the first embodiment.

FIG. 6 is a schematic cross-sectional view of a liquid crystal display device of a second embodiment.

FIG. 7 is a schematic cross-sectional view of a liquid crystal display device of a third embodiment.

FIG. 8 is a schematic cross-sectional view of a capacitive touch panel in the third embodiment which includes one transparent substrate.

FIG. 9 is a schematic plan view of the capacitive touch panel in the third embodiment which includes one transparent substrate.

FIG. 10 is a schematic cross-sectional view of a capacitive touch panel in the third embodiment which includes two transparent substrates.

FIG. 11 is a schematic plan view of the capacitive touch panel in the third embodiment which includes two transparent substrates.

FIG. 12 is a schematic cross-sectional view of a liquid crystal display device of a fourth embodiment.

FIG. 13 is a schematic cross-sectional view of a capacitive touch panel in the fourth embodiment which includes two transparent substrates.

FIG. 14 is a schematic plan view of the capacitive touch panel in the fourth embodiment which includes two transparent substrates.

FIG. 15 is a schematic cross-sectional view of a capacitive touch panel in the fourth embodiment which includes three transparent substrates.

FIG. 16 is a schematic plan view of the capacitive touch panel in the fourth embodiment which includes three transparent substrates.

### MODES FOR CARRYING OUT THE INVENTION

The present invention will be described in more detail with reference to drawings, based on the following embodiments which, however, do not limit the present invention.

### First Embodiment

FIG. 1 is a schematic cross-sectional view of a liquid crystal display device of a first embodiment. The liquid crystal display device of the first embodiment, as illustrated in FIG. 1, has a first substrate 1, a liquid crystal layer 3, and a second substrate 2 in this order toward the display surface. That is, the liquid crystal layer 3 is arranged between the second substrate 2 on the display surface side and the first substrate 1 on the inner side (back face side) of the liquid crystal display device. An array substrate 11 included in the first substrate 1, the liquid crystal layer 3, and a counter substrate 12 included in the second substrate 2 constitute a liquid crystal display (LCD) panel 10.

The liquid crystal layer 3 contains a liquid crystal material of which the molecules are aligned in specific directions upon application of a certain voltage. The kind of the liquid crystal material is not particularly limited, and is appropriately selected according to the control mode of liquid crystal molecules, such as the twisted nematic (TN) mode, vertical alignment (VA) mode, and in-plane switching (IPS) mode.

The first substrate 1 has the array substrate 11 constituting the LCD panel 10 and a polarizer (first polarizer) 21 in this order in the direction away from the liquid crystal layer 3. The array substrate 11 includes a colorless, transparent insulating substrate such as a glass substrate, and also includes, on the liquid crystal layer 3 side of the insulating substrate, bus lines such as scanning lines and data lines, switching elements such as thin-film transistors (TFTs), and pixel electrodes. The array substrate 11 also has an alignment film defining the initial inclination of liquid crystal molecules on the liquid crystal layer 3 side of the outermost surface thereof.

The second substrate 2 has a counter substrate 12 constituting the LCD panel 10, a polarizer (second polarizer) 22, a double-sided tape (interlayer) 30 consisting of an adhesive layer (first adhesive layer) 32 for a polarizer, a base material 31, and an adhesive layer (second adhesive layer) 33 for a protective plate, and a protective plate 40 in this order in the direction away from the liquid crystal layer 3, i.e., toward the display surface. The counter substrate 12 has a colorless, transparent insulating substrate such as a glass substrate, and has, on the liquid crystal layer 3 side of the insulating substrate, a black matrix (BM), color filters such as red, green, and blue, a common electrode, and an alignment film.

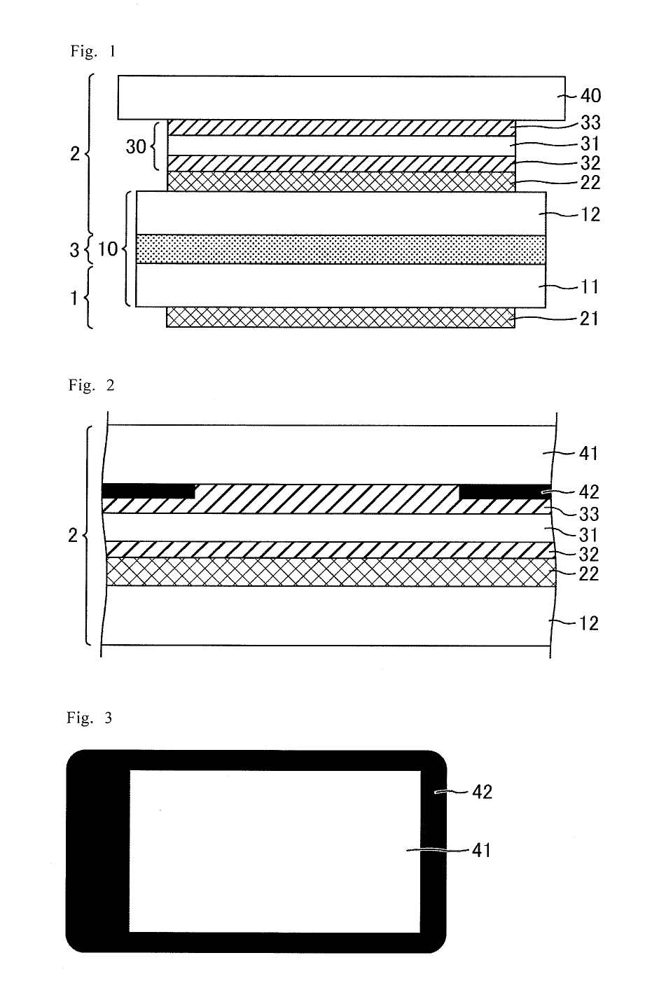

Hereinafter, the air-gapless (hereinafter also referred to as “AGL”) structure of the second substrate 2 is described in detail. FIG. 2 is a schematic cross-sectional view of a second substrate provided in the liquid crystal display device of the first embodiment. FIG. 3 is a schematic plan view of the second substrate provided in the liquid crystal display device of the first embodiment.

As illustrated in FIG. 2 and FIG. 3, the above respective components constituting the second substrate 2 are arranged closely to each other, without an air layer between the components. That is, the second substrate 2 has an AGL structure. In the structure of the liquid crystal display device of the first embodiment, the double-sided tape 30 is arranged between the polarizer 22 and the protective plate 40 where an air layer has been conventionally formed, and the polarizer 22 and the protective plate 40 are arranged closely to each other via the double-sided tape 30.

The protective plate 40 of the second substrate 2 includes a colorless, transparent cover substrate 41 constituting a window through which light is transmitted, and a black printed film 42 constituting the periphery portion that surrounds the window. For instance, in a cell phone, the display screen for displaying letters and images corresponds to the window, and the frame surrounding the display screen corresponds to the periphery portion.

The material of the cover substrate 41 constituting the window is suitably glass or plastics such as polymethyl methacryl acid (PMMA) and polycarbonate (PC). The material of the black printed film 42 constituting the periphery portion is not particularly limited. The thickness of the cover substrate 41 is preferably 0.6 to 0.8 mm and the thickness of the black printed film 42 is preferably 5 to 20 μm, in terms of the balance between the thickness and the reliability. The black printed film 42 is producible by, for example, screen printing.

In the structure of the liquid crystal display device of the first embodiment, the elastic modulus of the material of each of the two adhesive layers 32 and 33 constituting the double-sided tape 30 is not higher than 1.0×10⁵ Pa. In this case, a change in the thickness of the liquid crystal layer 3 caused by formation of the AGL structure can be suppressed. Even in the case that a component (in the present embodiment, black printed film 42) providing a level difference on the polarizer 22 or the protective plate 40 is arranged between the polarizer 22 and the protective plate 40, an elastic modulus in the above range prevents such a level difference from causing unevenness of the thickness of the liquid crystal layer 3. The thickness of the liquid crystal layer 3 can be uneven because of the irregularities on the surface of the polarizer 22, and such unevenness of the thickness of the liquid crystal layer 3 can also be suppressed by an adhesive layer having the above elastic modulus. Also, an elastic modulus of each of the adhesive layers 32 and 33 in the above range enables to reduce a change in the sizes of the respective components caused by thermal contraction of the polarizer 22 even in the case that the adhesive layer 32 is directly attached to the polarizer 22.

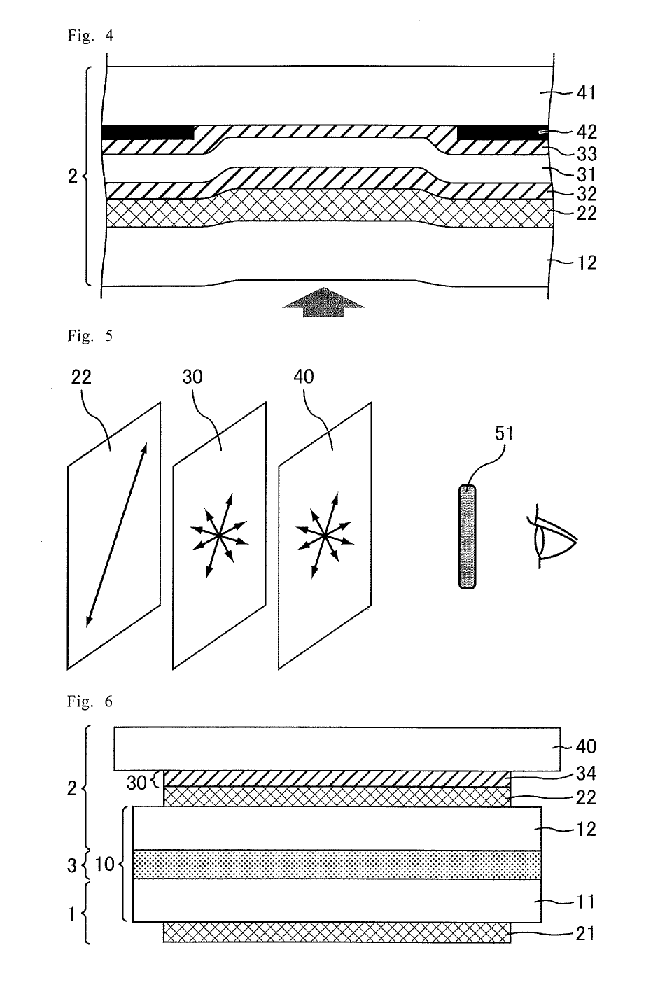

FIG. 4 is a schematic cross-sectional view of a substrate having the same structure as the second substrate in the present invention and including a conventionally used adhesive layer, after the substrate has received a certain amount of heat. The second substrate of the present invention does not suffer from much size change even when receiving a certain amount of heat because the adhesive layers 32 and 33 reduce the change. In contrast, in a conventional substrate as illustrated in FIG. 4, the sizes of the respective components are changed, particularly to the shape along the level difference of the black printed film 42, by thermal expansion or thermal contraction caused by heating, and thereby the thickness of the liquid crystal layer 3 becomes uneven. Specifically, the thickness of the liquid crystal layer 3 in the region without the black printed film 42 may be larger than that in the region with the black printed film 42 by 0.1 to 0.5 μm, in which case problems in optical properties tend to arise.

The materials of the two adhesive layers 32 and 33 in the first embodiment may be the same as or different from each other as long as the elastic moduli thereof are in the above range. Examples of the materials of the two adhesive layers 32 and 33, i.e., the adhesive layer 32 for a polarizer and the adhesive layer 33 for a protective plate, include acrylate polymers. Examples of the method for controlling the elastic modulus in the above range include: (1) the method of changing the glass transition temperature (Tg) of the material of the adhesive layer to a lower temperature; (2) in the case that the material of the adhesive layer is a polymer, the method of reducing the molecular weight of the polymer; and (3) in the case that the material of the adhesive layer is a polymer, the method of reducing the crosslinking density of the polymer. Examples of more specific control methods for the above methods (1) to (3) include, respectively, (1) a method of decreasing the polarity of the functional group to be introduced into the polymer such that the polarity of the whole polymer is decreased; (2) a method of controlling the degree of polymerization of the polymer; and (3) a method of reducing the crosslinking agent to be added in polymerization to produce the polymer. Examples of the method of measuring the elastic modulus of the material of each of the two adhesive layers 32 and 33 include measurement by the shear vibration—non-resonance method based on JIS K7244-6.

Examples of the material of the base material 31 in the double-sided tape 30 in the first embodiment include polyethylene terephthalate (PET), ARTON, PC and ZEONOR (registered trademark). The base material 31 has different refractive indexes in multiple directions (x direction and y direction) in a single plane, and is preferably formed through stretching in three or more directions.

FIG. 5 is a perspective conceptual view illustrating optical properties of respective components constituting an AGL structure of the liquid crystal display device of the first embodiment. As illustrated in FIG. 5, the AGL structure in the first embodiment is formed by arranging, in this order toward the display surface, the polarizer (second polarizer) 22; the double-sided tape 30 consisting of the base material and adhesive layers provided on respective both surfaces of the base material; and the protective plate 40 produced from glass, plastics, or the like.

The light used for display enters the backside of the polarizer 22 and then passes through the transmission axis of the polarizer 22 so as to be converted into polarized light which has an axis (vibration direction) in the same direction as the transmission axis. Then, the polarized light enters the double-sided tape 30 including the base material of which the optical properties modulate the polarization of the light, so that the light is converted into light having axes in multiple directions (x direction and y direction). The light having passed through the double-sided tape 30 enters the protective plate 40, and is emitted out into the air without being affected by the protective plate 40 that practically does not have birefringence. Disturbing the polarization of the light as above eliminates the phenomenon in which no image appears on the display at a certain viewing angle when the display screen is viewed through the polarized sunglasses 51. Hence, display becomes visible without any inconvenience even when the display screen is viewed through the polarized sunglasses 51.

Particularly, since many of the mobile terminals today can provide display in both landscape mode and portrait mode, being available for viewing through polarized sunglasses in only one of the modes is insufficient. In this context, the liquid crystal display device of the first embodiment has a structure in which the base material 31 in the double-sided tape 30 between the polarizer 22 and the protective plate 40 is used to provide good display in both modes without an extra increase in the thickness; hence, the display device supports both landscape mode and portrait mode, and is suitable for thin mobile terminals. Specifically, in the case that a biaxial phase plate is attached between the polarizer 22 and the protective plate 40 in addition to the base material 31 and the adhesive layers 32 and 33, the thickness probably increases by about 100 μm. Also, in the case that the biaxial phase plate and the adhesive layers 32 and 33 are in direct contact with each other, peeling may occur between the biaxial phase plate and the adhesive layers 32 and 33.

Each of the adhesive layer 32 for a polarizer and the adhesive layer 33 for a protective plate preferably has a thickness of 50 to 200 μm and the base material 31 preferably has a thickness of 17 to 50 μm, in terms of the balance between the thickness and the reliability. The suitable numerical value of the elastic modulus of each of the adhesive layers 32 and 33 varies according to the thickness of each of the adhesive layers 32 and 33, the material of the base material 31, and the material of the protective plate 40. The elastic modulus of the adhesive layer is preferably lower if the adhesive layer is attached to a component containing a harder material.

### Evaluation Test 1

In the following, the results of studies on the suitable design for the base material and the adhesive layer used for the liquid crystal display device of the first embodiment are shown. In Evaluation Test 1, a 3 inch WVGA liquid crystal display panel was used as a base panel. The protective plates used were of two kinds, glass and plastic, and each plate had a thickness of 1.0 mm. The plastic was, specifically, PMMA (trade name: MR200, product of Mitsubishi Rayon Co., Ltd.).

The thickness of the adhesive layer evaluated was either 100 μm or 200 μm. Further, a total of 10 samples was used for evaluation of the elastic modulus (Pa) of the adhesive layer, namely sample A (2.3×10⁷), sample B (7.7×10⁶), sample C (3.4×10⁶), sample D (8.9×10⁵), sample E (5.8×10⁵), sample F (1.3×10⁵), sample G (9.2×10⁴), sample H (5.1×10⁴), sample I (1.1×10⁴), and sample J (6.2×10³).

The material of the base material was PET in every sample. The thickness of each base material was 25 micrometers. The elastic modulus of the adhesive layer of each sample was measured by the shear vibration—non-resonance method based on JIS K7244-6.

Table 1 and Table 2 each show the results of evaluation of display qualities of each LCD panel produced under such conditions. Table 1 shows the results in the case that the thickness of the adhesive layer was 200 μm. Table 2 shows the results in the case that the thickness of the adhesive layer was 100 μm.

TABLE 1

| | Sample A | Sample B | Sample C | Sample D | Sample E |
|---|---|---|---|---|---|
| Elastic | 2.3.E+07 | 7.7.E+06 | 3.4.E+06 | 8.9.E+05 | 5.8.E+05 |
| modulus (Pa) | | | | | |
| Glass | 42° C. | 24° C. | 23° C. | 18° C. | 18° C. |
| transition | | | | | |
| temperature | | | | | |
| Tg | | | | | |
| On glass | − | − | − | + | + |
| On plastic | + | + | ++ | ++ | ++ |
| | Sample F | Sample G | Sample H | Sample I | Sample J |
| Elastic | 1.3.E+05 | 9.2.E+04 | 5.1.E+04 | 1.1.E+04 | 6.2.E+03 |
| modulus (Pa) | | | | | |
| Glass | 8° C. | −2° C. | −9° C. | −16° C. | −23° C. |
| transition | | | | | |
| temperature | | | | | |
| Tg | | | | | |
| On glass | ++ | ++ | ++ | ++ | ++ |
| On plastic | ++ | ++ | ++ | ++ | ++ |

TABLE 2

| | Sample A | Sample B | Sample C | Sample D | Sample E |
|---|---|---|---|---|---|
| Elastic | 2.3.E+07 | 7.7.E+06 | 3.4.E+06 | 8.9.E+05 | 5.8.E+05 |
| modulus (Pa) | | | | | |
| Glass | 42° C. | 24° C. | 23° C. | 18° C. | 18° C. |
| transition | | | | | |
| temperature | | | | | |
| Tg | | | | | |
| On glass | − | − | − | − | + |
| On plastic | − | + | + | ++ | ++ |
| | Sample F | Sample G | Sample H | Sample I | Sample J |
| Elastic | 1.3.E+05 | 9.2.E+04 | 5.1.E+04 | 1.1.E+04 | 6.2.E+03 |
| modulus (Pa) | | | | | |
| Glass | 8° C. | −2° C. | −9° C. | −16° C. | −23° C. |
| transition | | | | | |
| temperature | | | | | |
| Tg | | | | | |
| On glass | + | ++ | ++ | ++ | ++ |
| On plastic | ++ | ++ | ++ | ++ | ++ |

In Table 1 and Table 2, ++ indicates that no display unevenness was found, + indicates that display unevenness was found but was of an acceptable level, and − indicates that display unevenness was found and the display qualities were poor. The display unevenness in the case of “+” showed a frame-like shape, and thus was probably caused by the level difference provided by the black printed film. Meanwhile, the display unevenness in the case of “−” showed the shape of the frame as well as shapes probably caused by the irregularities on the polarizer.

The results in Table 1 show that, in the case that the material of the protective plate is glass having a thickness of 200 μm, display unevenness due to the irregularities on the polarizer can be prevented by setting the elastic modulus at least to a value not higher than 8.9×10⁵ (Pa), and display unevenness can be entirely prevented by setting the elastic modulus to a value not higher than 1.3×10⁵ (Pa).

The results also show that, in the case that the material of the protective plate is plastic (PMMA) having a thickness of 200 μm, display unevenness due to the irregularities on the polarizer can be prevented by setting the elastic modulus at least to a value not higher than 2.3×10⁷ (Pa), and display unevenness can be entirely prevented by setting the elastic modulus to a value not higher than 3.4×10⁶ (Pa).

The results in Table 2 show that, in the case that the material of the protective plate is glass having a thickness of 100 μm, display unevenness due to the irregularities on the polarizer can be prevented by setting the elastic modulus at least to a value not higher than 5.8×10⁵ (Pa), and display unevenness can be entirely prevented by setting the elastic modulus to a value not higher than 9.2×10⁴ (Pa).

The results also show that, in the case that the material of the protective plate is plastic (PMMA) having a thickness of 100 μm, display unevenness due to the irregularities on the polarizer can be prevented by setting the elastic modulus at least to a value not higher than 7.7×10⁶ (Pa), and display unevenness can be entirely prevented by setting the elastic modulus to a value not higher than 8.9×10⁵ (Pa).

Also, these results show that a liquid crystal display panel on which display unevenness due to the irregularities on the polarizer is not observed can be obtained by arranging a base material, sandwiched by adhesive layers each having an elastic modulus not higher than 1.0×10⁶, between the polarizer and the protective plate regardless of the thickness and material of the protective plate.

The results also show that, even in the case that a black printed film constituting the periphery portion is formed, a good liquid crystal display panel on which the entire display unevenness including display unevenness caused by the printed film is not observed can be obtained by arranging a base material, sandwiched by adhesive layers each having an elastic modulus not higher than 1.0×10⁶, between the polarizer and the protective plate regardless of the thickness and material of the protective plate.

### Second Embodiment

FIG. 6 is a schematic cross-sectional view of a liquid crystal display device of a second embodiment. As illustrated in FIG. 6, the liquid crystal display device of the second embodiment is the same as the liquid crystal display device of the first embodiment in that the liquid crystal display device has the first substrate 1, the liquid crystal layer 3, and the second substrate 2 in this order toward the display surface, and the array substrate 11 included in the first substrate 1, the liquid crystal layer 3, and the counter substrate 12 included in the second substrate 2 constitute the liquid crystal display (LCD) panel 10. The liquid crystal display device of the second embodiment is different from the liquid crystal display device of the first embodiment in that the double-sided tape 30 in the second substrate 2 consists only of one layer which is an adhesive layer 34. That is, the second substrate in the second embodiment has the counter substrate 12 constituting the LCD panel 10, the polarizer (second polarizer) 22, the double-sided tape (interlayer) 30 consisting of the adhesive layer 34, and the protective plate 40 in this order in the direction away from the liquid crystal layer, i.e., toward the display surface.

Since the elastic modulus of the material of the adhesive layer 34 is not higher than 1.0×10⁵ Pa as in the first embodiment, the liquid crystal layer can be prevented from having uneven thickness even in the case of having the AGL structure as in the first embodiment.

The liquid crystal display device of the second embodiment does not have the base material and has only one adhesive layer unlike the liquid crystal display device of the first embodiment, and therefore the distance between the polarizer 22 and the protective plate 40 can be further shortened. Accordingly, the display device can be suitably used for mobile equipment and the like which are desired to be thinned. Specifically, the liquid crystal display device of the second embodiment is considered to be able to have a thickness smaller than the liquid crystal display device of the first embodiment by about 100 to 200 μm.

### Evaluation Test 2

In the following, the results of studies on the suitable design for the adhesive layer used for the liquid crystal display device of the second embodiment are shown. In Evaluation Test 2, a 3 inch WVGA liquid crystal display panel was used as a base panel. The protective plates used were of two kinds, glass and plastic, and each plate had a thickness of 1.0 mm. The plastic was, specifically, PMMA (trade name: MR200, product of Mitsubishi Rayon Co., Ltd.).

The thickness of the adhesive layer evaluated was either 100 μm or 200 μm. Further, a total of 10 samples was used for evaluation of the elastic modulus (Pa) of the adhesive layer, namely sample A (2.3×10⁷), sample B (7.7×10⁶), sample C (3.4×10⁶), sample D (8.9×10⁵), sample E (5.8×10⁵), sample F (1.3×10⁵), sample G (9.2×10⁴), sample H (5.1×10⁴), sample I (1.1×10⁴), and sample J (6.2×10³). The elastic modulus of the adhesive layer of each sample measured by the shear vibration—non-resonance method was based on JIS K7244-6.

Table 3 and Table 4 each show the result of evaluation of display qualities of each LCD panel produced under such conditions. Table 3 shows the results in the case that the thickness of the adhesive layer was 200 μm. Table 4 shows the result in the case that the thickness of the adhesive layer was 100 μm.

TABLE 3

| | Sample A | Sample B | Sample C | Sample D | Sample E |
|---|---|---|---|---|---|
| Elastic | 2.3.E+07 | 7.7.E+06 | 3.4.E+06 | 8.9.E+05 | 5.8.E+05 |
| modulus (Pa) | | | | | |
| Glass | 42° C. | 24° C. | 23° C. | 18° C. | 18° C. |
| transition | | | | | |
| temperature | | | | | |
| Tg | | | | | |
| On glass | − | − | − | − | − |
| On plastic | − | − | − | + | ++ |
| | Sample F | Sample G | Sample H | Sample I | Sample J |
| Elastic | 1.3.E+05 | 9.2.E+04 | 5.1.E+04 | 1.1.E+04 | 6.2.E+03 |
| modulus (Pa) | | | | | |
| Glass | 8° C. | −2° C. | −9° C. | −16° C. | −23° C. |
| transition | | | | | |
| temperature | | | | | |
| Tg | | | | | |
| On glass | + | + | ++ | ++ | ++ |
| On plastic | ++ | ++ | ++ | ++ | ++ |

TABLE 4

| | Sample A | Sample B | Sample C | Sample D | Sample E |
|---|---|---|---|---|---|
| Elastic | 2.3.E+07 | 7.7.E+06 | 3.4.E+06 | 8.9.E+05 | 5.8.E+05 |
| modulus (Pa) | | | | | |
| Glass | 42° C. | 24° C. | 23° C. | 18° C. | 18° C. |
| transition | | | | | |
| temperature | | | | | |
| Tg | | | | | |
| On glass | − | − | − | − | + |
| On plastic | − | − | − | + | + |
| | Sample F | Sample G | Sample H | Sample I | Sample J |
| Elastic | 1.3.E+05 | 9.2.E+04 | 5.1.E+04 | 1.1.E+04 | 6.2.E+03 |
| modulus (Pa) | | | | | |
| Glass | 8° C. | −2° C. | −9° C. | −16° C. | −23° C. |
| transition | | | | | |
| temperature | | | | | |
| Tg | | | | | |
| On glass | + | + | + | + | ++ |
| On plastic | + | ++ | ++ | ++ | ++ |

In Table 3 and Table 4, ++ indicates that no display unevenness was found, + indicates that display unevenness was found but was of an acceptable level, and − indicates that display unevenness was found and the display qualities were poor. The display unevenness in the case of “+” showed a frame-like shape, and thus was probably caused by the level difference provided by the black printed film. Meanwhile, the display unevenness in the case of “−” showed the shape of the frame as well as shapes probably caused by the irregularities on the polarizer.

The results in Table 3 show that, in the case that the material of the protective plate is glass having a thickness of 200 μm, display unevenness due to the irregularities on the polarizer can be prevented by setting the elastic modulus at least to a value not higher than 1.3×10⁵ (Pa), and display unevenness can be entirely prevented by setting the elastic modulus to a value not higher than 5.1×10⁴ (Pa).

The results also show that, in the case that the material of the protective plate is plastic (PMMA) having a thickness of 200 μm, display unevenness due to the irregularities on the polarizer can be prevented by setting the elastic modulus at least to a value not higher than 8.9×10⁵ (Pa), and display unevenness can be entirely prevented by setting the elastic modulus to a value not higher than 5.8×10⁵ (Pa).

The results in Table 4 show that, in the case that the material of the protective plate is glass having a thickness of 100 μm, display unevenness due to the irregularities on the polarizer can be prevented by setting the elastic modulus at least to a value not higher than 5.8×10⁵ (Pa), and display unevenness can be entirely prevented by setting the elastic modulus to a value not higher than 6.2×10³ (Pa).

The results also show that, in the case that the material of the protective plate is plastics (PMMA) having a thickness of 100 μm, display unevenness due to the irregularities on the polarizer can be prevented by setting the elastic modulus at least to a value not higher than 8.9×10⁵ (Pa), and display unevenness can be entirely prevented by setting the elastic modulus to a value not higher than 9.2×10⁴ (Pa).

Also, these results show that a liquid crystal display panel on which display unevenness due to the irregularities on the polarizer is not observed can be obtained by arranging an adhesive layer, having an elastic modulus not higher than 1.0×10⁵, between the polarizer and the protective plate regardless of the thickness and material of the protective plate.

The results also show that, even in the case that a black printed film constituting the periphery portion is formed, a good liquid crystal display panel on which the entire display unevenness including display unevenness caused by the printed film is not observed can be obtained by arranging an adhesive layer, having an elastic modulus not higher than 1.0×10⁴, between the polarizer and the protective plate regardless of the thickness and material of the protective plate.

### Third Embodiment

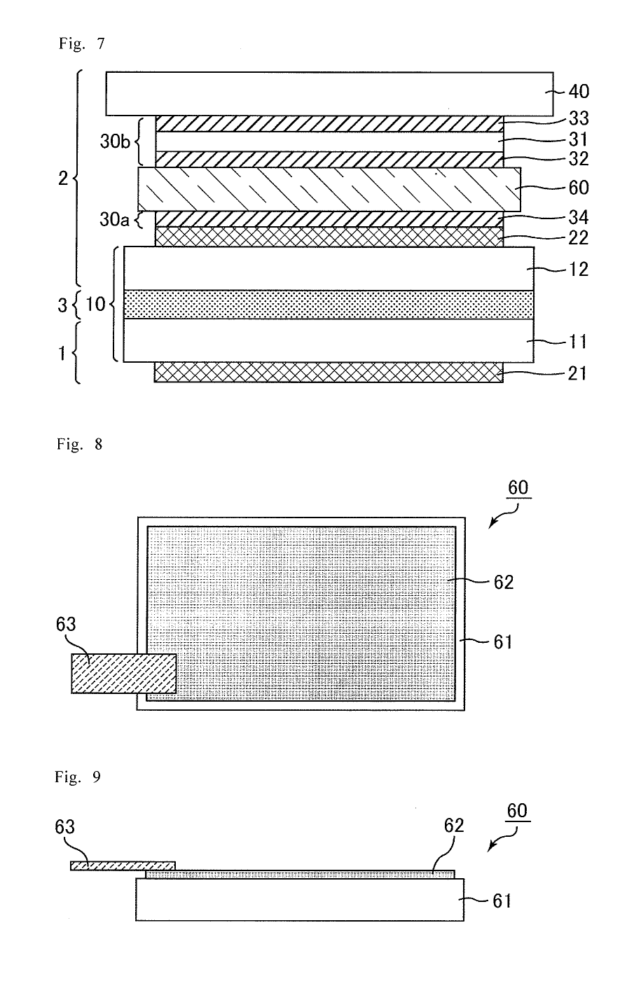

FIG. 7 is a schematic cross-sectional view of a liquid crystal display device of a third embodiment. As illustrated in FIG. 7, the liquid crystal display device of the third embodiment is the same as the liquid crystal display device of the first embodiment in that the liquid crystal display device has a first substrate, a liquid crystal layer, and a second substrate in this order toward the display surface, and the array substrate 11 included in the first substrate 1, the liquid crystal layer 3, and the counter substrate 12 included in the second substrate 2 constitute the LCD panel 10. The liquid crystal display device of the third embodiment is different from the liquid crystal display device of the first embodiment in that a capacitive touch panel 60 is included as a component. That is, the second substrate in the third embodiment has a counter substrate 12 constituting the LCD panel 10, a polarizer (second polarizer), a double-sided tape 30a consisting of the adhesive layer (third adhesive layer) 34, the capacitive touch panel 60, a double-sided tape 30b consisting of the adhesive layer (first adhesive layer) 32, the base material 31, and the adhesive layer (second adhesive layer) 33, and the protective plate 40 in this order in the direction away from the liquid crystal layer, i.e., toward the display surface. In the third embodiment, the double-sided tape 30a, the capacitive touch panel 60, and the double-sided tape 30b constitute the interlayer.

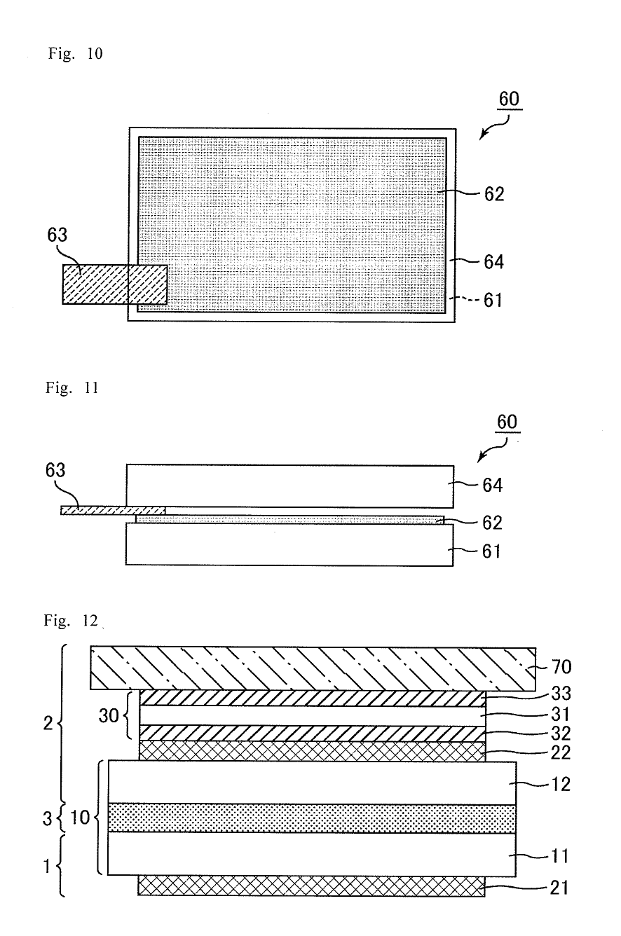

The structure of the capacitive touch panel 60 is described in detail. The capacitive touch panel 60 in the third embodiment has either one transparent substrate or two transparent substrates. FIG. 8 and FIG. 9 are schematic views of a capacitive touch panel in the third embodiment which includes one transparent substrate; here, FIG. 8 is a cross-sectional view, and FIG. 9 is a plan view. FIG. 10 and FIG. 11 are schematic views of a capacitive touch panel in the third embodiment which includes two transparent substrates; here, FIG. 10 is a cross-sectional view, and FIG. 11 is a plan view.

As illustrated in FIG. 8 and FIG. 9, the capacitive touch panel 60 including one transparent substrate has a transparent substrate 61 produced from glass or plastics (PET, PMMA, or PC), a transparent conductive film 62 arranged on the transparent substrate 61, and a flexible printed circuit (FPC) substrate 63 that has conductive components (e.g. bumps) at positions in contact with the transparent conductive film 62. The FPC 63 is mounted with the drive circuit of the capacitive touch panel 60, and detects the position of finger touch based on the change in the capacitance transmitted from the transparent conductive film 62. The material of the transparent conductive film 62 is suitably a metal oxide such as indium tin oxide (ITO).

As illustrated in FIG. 10 and FIG. 11, the capacitive touch panel 60 including two transparent substrates has the bottom transparent substrate 61 produced from plastic (PET, PMMA, or PC), the transparent conductive film 62 arranged on the bottom transparent substrate 61, the flexible printed circuit (FPC) substrate 63 that has conductive components (e.g. bumps) at positions in contact with the transparent conductive film 62, and a top transparent substrate 64 produced from plastic (PET, PMMA, or PC). The FPC 63 is mounted with the drive circuit of the capacitive touch panel 60, and detects the position of finger touch based on the change in the capacitance transmitted from the transparent conductive film 62. The material of the transparent conductive film 62 is suitably a metal oxide such as indium tin oxide (ITO). In the case of two transparent substrates, each of the transparent substrates 61 and 64 is preferably produced from plastic (PET, PMMA, or PC) unlike the case of one transparent substrate.

Since the elastic modulus of the material of each of the adhesive layers 32, 33, and 34 is not higher than 1.0×10⁵ Pa as in the first embodiment, the liquid crystal layer 3 can be prevented from having uneven thickness as in the first embodiment even in the case of having the AGL structure including a capacitive touch panel.

Hereinabove, the structure has been described in which the double-sided tape 30a not including a base material is arranged on the backside (inner side of the liquid crystal display device) of the capacitive touch panel 60 and the double-sided tape 30b including the base material 31 is arranged on the display surface side of the capacitive touch panel 60. In the third embodiment, however, inclusion of the base material is not particularly limited as long as a double-sided tape is arranged on either side of the capacitive touch panel 60.

That is, the structure of the interlayer in the third embodiment may be a structure in which a double-sided tape including no base material is arranged on either side of the capacitive touch panel; a structure in which a double-sided tape including a base material is arranged on either side of the capacitive touch panel; or a structure in which a double-sided tape including a base material is arranged on the backside (inner side of the liquid crystal display device) of the capacitive touch panel and a double-sided tape including no base material is arranged on the display surface side of the capacitive touch panel.

### Fourth Embodiment

FIG. 12 is a schematic cross-sectional view of a liquid crystal display device of a fourth embodiment. As illustrated in FIG. 12, the liquid crystal display device of the fourth embodiment is the same as the liquid crystal display device of the first embodiment in that the liquid crystal display device has the first substrate 1, the liquid crystal layer 3, and the second substrate 2 in this order toward the display surface, and the array substrate 11 included in the first substrate 1, the liquid crystal layer 3, and the counter substrate 12 included in the second substrate 2 constitute the LCD panel 10. The liquid crystal display device of the fourth embodiment is different from the liquid crystal display device of the first embodiment in that the protective plate of the second substrate 2 constitutes a resistive touch panel 70. That is, the second substrate 2 in the fourth embodiment has the counter substrate 12 constituting the LCD panel 10, the polarizer (second polarizer) 22, the double-sided tape (interlayer) 30 consisting of the adhesive layer (first adhesive layer) 32, the base material 31, and the adhesive layer (second adhesive layer) 33, and the resistive touch panel 70 in this order in the direction away from the liquid crystal layer 3, i.e., toward the display surface.

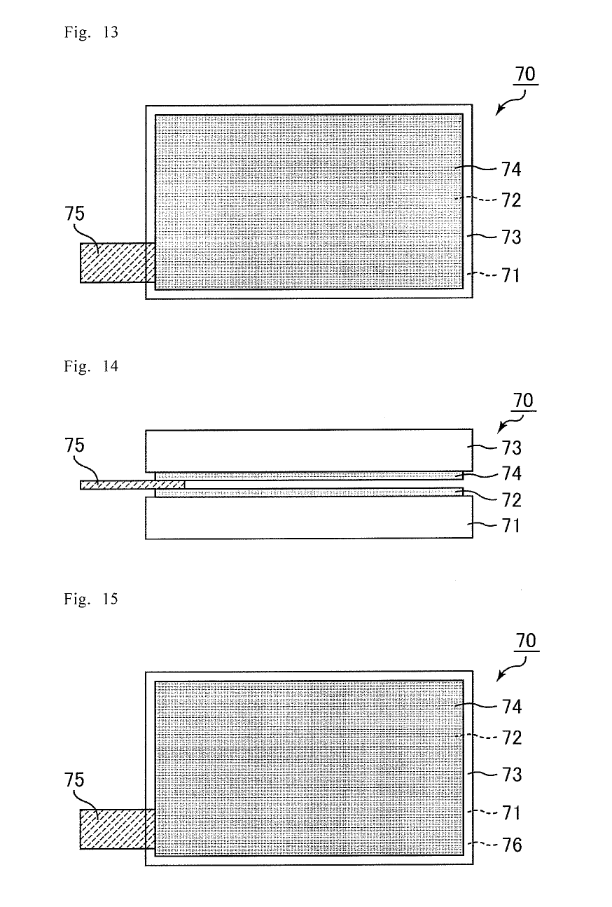

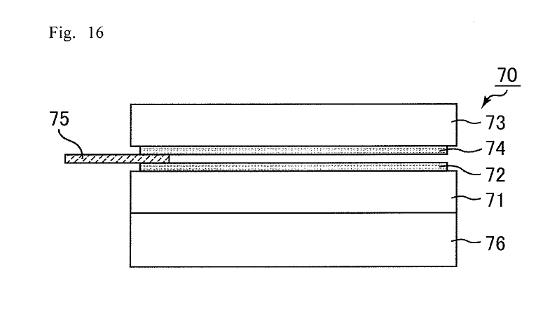

The structure of the resistive touch panel 70 is described in more detail. The resistive touch panel in the fourth embodiment has either two transparent substrates or three transparent substrates. FIG. 13 and FIG. 14 are schematic views of a resistive touch panel in the fourth embodiment which includes two transparent substrates; here, FIG. 13 is a cross-sectional view, and FIG. 14 is a plan view. FIG. 15 and FIG. 16 are schematic views of a resistive touch panel in the fourth embodiment which includes three transparent substrates; here, FIG. 15 is a cross-sectional view, and FIG. 16 is a plan view.

As illustrated in FIG. 13 and FIG. 14, the resistive touch panel 70 including two transparent substrates has a bottom transparent substrate 71 produced from glass or plastic (PET), a top transparent substrate produced from plastic (such as PET), a transparent conductive film 72 arranged on the bottom transparent substrate 71, a transparent conductive film 74 arranged underneath the top transparent substrate 73, and a flexible printed circuit (FPC) substrate 75 that has conductive components (e.g. bumps) at positions in contact with the transparent conductive films 72 and 74. The FPC 75 is mounted with the drive circuit of the resistive touch panel 70, and detects finger touch based on the current which is generated upon contact between the electrodes caused by the finger pressure and is transmitted from the transparent conductive film. The material of each of the transparent conductive films 72 and 74 is suitably a metal oxide such as indium tin oxide (ITO). In the case of two transparent substrates, the bottom transparent substrate 71 is preferably produced from glass harder than the top transparent substrate 73 or from plastics as hard as the top transparent substrate 73, that is, the top transparent substrate 73 is preferably produced from plastic softer than or as hard as the bottom transparent substrate 71.

As illustrated in FIG. 15 and FIG. 16, the resistive touch panel including three transparent substrates has a bottom transparent substrate 76 produced from glass or plastic (PMMA or PC), a middle transparent substrate 71 produced from plastic (PET) and arranged closely to the bottom transparent substrate 76, the top transparent substrate 73 produced from plastic (such as PET), the transparent conductive film 72 arranged on the middle transparent substrate 71, the transparent conductive film 74 arranged underneath the top transparent substrate 73, and the flexible printed circuit (FPC) substrate 75 that has conductive components (e.g. bumps) at positions in contact with the transparent conductive films 72 and 74. The FPC 75 is mounted with the drive circuit of the resistive touch panel 70, and detects finger touch based on the current which is generated upon contact between the electrodes caused by the finger pressure and is transmitted from the transparent conductive films 72 and 74. The material of each of the transparent conductive films 72 and 74 is suitably a metal oxide such as indium tin oxide (ITO). In the case of three transparent substrates, the bottom transparent substrate 76 located closer to the backside is preferably the hardest among the transparent substrates 71, 73, and 76, the middle transparent substrate 71 is a plastic softer than the bottom transparent substrate 76, and the top transparent substrate 73 is a plastic as hard as the middle transparent substrate 71.

Since the elastic modulus of the material of each of the adhesive layers 32 and 33 is not higher than 1.0×10⁵ Pa as in the first embodiment, the liquid crystal layer 3 can be prevented from having uneven thickness as in the first embodiment even in the case of having the AGL structure including a resistive touch panel.

Hereinabove, the structure has been described in which the double-sided tape 30 including the base material 31 is arranged on the backside (inner side of the liquid crystal display device) of the resistive touch panel 70. The double-sided tape in the fourth embodiment, however, may be one including no base material as in the second embodiment.

The present application claims priority to Patent Application No. 2009-132476 filed in Japan on Jun. 1, 2009 under the Paris Convention and provisions of national law in a designated State, the entire contents of which are hereby incorporated by reference.

### EXPLANATION OF SYMBOLS

1: First substrate
2: Second substrate
3: Liquid crystal layer
10: Liquid crystal display (LCD) panel
11: Array substrate
12: Counter substrate
21, 22: Polarizer
30, 30a, 30b: Double-sided tape
31: Base material
32, 33, 34: Adhesive layer
40: Protective plate
41: Cover substrate
42: Printed film
51: Polarized sunglasses
60: Capacitive touch panel
61, 64, 65, 71, 73, 76: Transparent substrate
62, 72, 74: Transparent conductive film (ITO)
63, 75: Flexible printed circuit (FPC) substrate
70: Resistive touch panel

1. A liquid crystal display device comprising, in this order toward a display surface:
a first substrate;
a liquid crystal layer; and
a second substrate,
the second substrate containing, in this order toward the display surface, a polarizer, an interlayer including an adhesive layer, and a protective plate,
the polarizer and the protective plate being in close contact with each other via the interlayer,
the adhesive layer containing a material that has an elastic modulus of not higher than 1.0×10⁵ Pa.

2. The liquid crystal display device according to claim 1, wherein the interlayer includes a double-sided tape consisting of an adhesive layer.

3. The liquid crystal display device according to claim 1, wherein the interlayer includes a double-sided tape consisting of a first adhesive layer, a base material, and a second adhesive layer.

4. The liquid crystal display device according to claim 3, wherein the base material has different refractive indexes in respective directions within a single plane.

5. The liquid crystal display device according to claim 1, wherein the interlayer further includes a capacitive touch panel.

6. The liquid crystal display device according to claim 1, wherein the protective plate is a resistive touch panel.
